(19) United States
(12) Patent Application Publication
(10) Pub. No.: US 2015/0349620 A1
(43) Pub. Date: Dec. 3, 2015

(54) HORIZONTALLY ROTATING DRIVING APPARATUS

(71) Applicants: YI-PING HSU, KAOHSIUNG CITY (TW); CHIA-MING HSU, KAOHSIUNG CITY (TW); TING-CHEN HSU, KAOHSIUNG CITY (TW); YU-LIEN HSU CHU, KAOHSIUNG CITY (TW); KUN-TIEN WU, KAOHSIUNG CITY (TW); CHI-YUAN WU, KAOHSIUNG CITY (TW); YING-ZHUN WU, KAOHSIUNG CITY (TW)

(72) Inventors: YI-PING HSU, KAOHSIUNG CITY (TW); CHIA-MING HSU, KAOHSIUNG CITY (TW); TING-CHEN HSU, KAOHSIUNG CITY (TW); YU-LIEN HSU CHU, KAOHSIUNG CITY (TW); KUN-TIEN WU, KAOHSIUNG CITY (TW); CHI-YUAN WU, KAOHSIUNG CITY (TW); YING-ZHUN WU, KAOHSIUNG CITY (TW)

(21) Appl. No.: 14/548,445

(22) Filed: Nov. 20, 2014

(30) Foreign Application Priority Data
May 28, 2014 (TW) 103118624

(51) Int. Cl. H02K 47/00; H02K 11/00; H02K 21/12

(52) U.S. Cl. CPC H02K 47/00; H02K 21/12; H02K 11/0021

(57) ABSTRACT

A horizontally rotating driving apparatus is connected with a longitudinal rotating shaft and includes a frame, a rotating unit, multiple electromagnetic units and multiple sensor switch units. The frame is mounted on the rotating shaft and has an inner space formed inside the frame. The rotating unit is located in the inner space of the frame and is horizontally and rotatably mounted on the rotating shaft to form a rotation path. The electromagnetic units are disposed in the inner space of the frame and are arranged along the rotation path of the rotating unit. The sensor switch units are mounted in the frame and are disposed in the inner space of the frame at identical intervals. When one of the magnetic portions passes the sensor switch units, the sensor switch units sequentially control the electromagnetic units to start or to stop generating magnetic force and rotate the rotating unit.

### BACKGROUND OF THE INVENTION

1. Field of the Invention

The present invention relates to a driving apparatus, and more particularly to a horizontally rotating driving apparatus.

2. Description of Related Art

The conventional generator translates mechanical energy to electrical energy by a driving apparatus, such as a fan by wind power, a waterwheel by hydropower or an internal combustion engine by thermal power.

The conventional driving apparatus work based on natural force to translate the nature forces to electricity power, and have low efficiency in transformation from mechanical energy to electrical energy.

To overcome the shortcomings of the conventional driving apparatus, the present invention provides a horizontally rotating driving apparatus to mitigate or obviate the aforementioned problems.

### SUMMARY OF THE INVENTION

In order to reach the said invention objective, the present invention provides a horizontally rotating driving apparatus. The rotating driving apparatus is connected with a rotating shaft and includes a frame, a rotating unit, multiple electromagnetic units, and multiple sensor switch units.

The frame is mounted on the rotating shaft and has an inner space formed inside the frame. The rotating unit is located in the inner space of the frame and is rotatably mounted on the rotating shaft to form a rotation path. The electromagnetic units are disposed in the inner space of the frame and are arranged along the rotation path of the rotating unit. The sensor switch units are mounted in the frame and are disposed in the inner space of the frame at identical intervals.

When one of the magnetic portions pass the sensor switch units, the sensor switch units sequentially control the electromagnetic units to start or stop generating magnetic force and drive the rotating unit to rotate.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional top view of a first embodiment of a horizontally rotating driving apparatus in accordance with the present invention;

FIG. 2 is a cross-sectional side view of the horizontally rotating driving apparatus in FIG. 1;

FIG. 3 is a cross-sectional top view of a second embodiment of a horizontally rotating driving apparatus in accordance with the present invention;

FIG. 4 is a perspective view of a third embodiment of a horizontally rotating driving apparatus in accordance with the present invention;

FIG. 5 is a cross-sectional top view of the horizontally rotating driving apparatus in FIG. 4; and

FIG. 6 is a cross-sectional side view of the horizontally rotating driving apparatus in FIG. 4.

### DETAILED DESCRIPTION OF PREFERRED EMBODIMENT

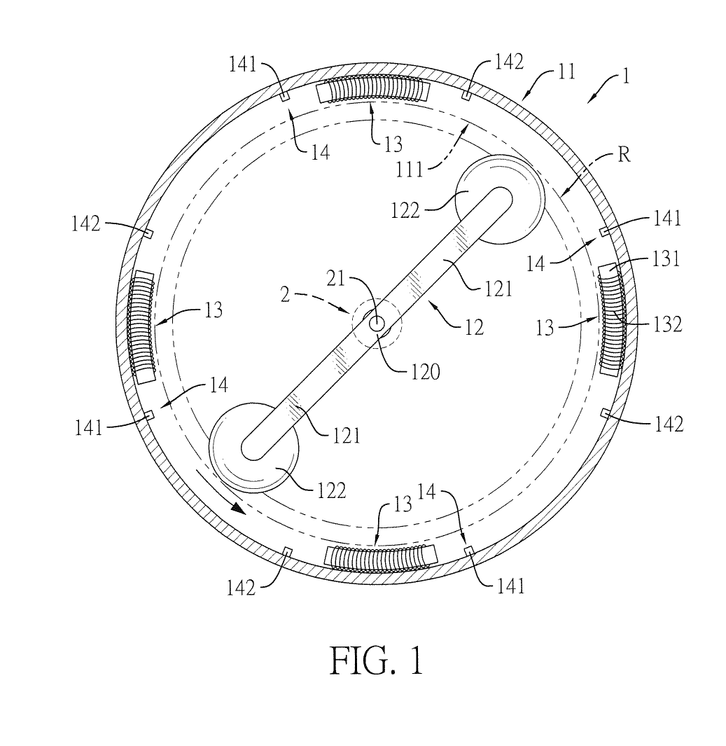

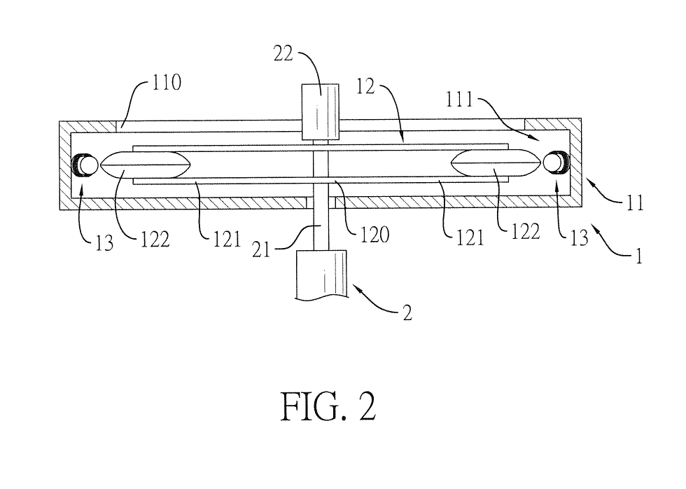

With reference to FIGS. 1 and 2, a first preferred embodiment of a horizontally rotating driving apparatus 1 is connected with an electrical generator 2. The electrical generator 2 includes a rotating shaft 21 and a switch device 22. The rotating shaft 21 extends toward a horizontal direction.

The rotating driving apparatus 1 is mounted on the rotating shaft 21 and is connected with the switch device 22.

With reference to FIGS. 1 and 2, the rotating driving apparatus 1 includes a frame 11, a rotating unit 12, multiple electromagnetic units 13, and multiple sensor switch units 14.

The frame 11 is connected with the rotating shaft 21. The frame 11 is a wheel-shape and has a top surface, a center, an inner wall, an opening 110 formed at the center of the top surface, and an inner space 111 formed inside the frame11 and communicates with the opening 110.The rotating shaft 22 is located at the center of the frame 11.

The rotating unit 12 is horizontally and rotatably mounted on the rotating shaft 21, is located in the inner space 111 of the frame 11, and includes a rotating center 120, multiple rotating arms 121 and multiple magnetic portions 122. The rotating center 120 is located at the central point of the rotating unit 12 and is connected with the rotating shaft 21. The rotating arms 121 respectively extend from the rotating center 120 toward a radial direction of the rotating shaft 21 and are arranged at identical intervals. Each rotating arm 121 has an end portion. The magnetic portions 122 are made of magnetic materials and are respectively mounted on the end portions of the rotating arms 121. Preferably, two rotating arms 121 are implemented and are arranged along a same radial direction and are diametrically opposite to each other. The magnetic portions 122 are each formed in a disc-shape which is thick in a central portion of the magnetic portion 122 and thin in a periphery of the magnetic portion 122.

The rotating unit 12 can horizontally rotate in the frame 11 toward a single direction, such as clockwise or anticlockwise. Preferably, the rotating unit 12 rotates anticlockwise in the frame 11 and forms an anticlockwise rotation path R. When the rotating unit 12 rotates, the shape of the magnetic portions 122 can decrease windage of rotating and increase the rotating efficiency. Furthermore, the amount of the rotating arms 121 and the magnetic portions 122 of the rotating unit can be added, depending on demand.

The electromagnetic units 13 are disposed in the inner space 111 of the frame 11, are arranged along the rotation path R of the rotating unit 12, are respectively mounted in the inner wall of the frame 11 at identical intervals, and are located adjacent to the magnetic portions 122 of the rotating unit 12. Preferably, each electromagnetic unit 13 includes an electromagnet 131 and a coil 132 coiled around the electromagnet 131. The coil 132 is connected with an external power supplier such as a solar battery, to supply electricity to the electromagnet 131 and to drive the electromagnet 131. The electromagnetic units 13 are controllable to generate magnetism or to stop generating magnetic force, when the coil 132 is electrically connected or disconnected. Hence, the magnetic portions 122 of the rotating unit 12 are attracted by the electromagnetic units 13 to assist the movement of the rotating arms 121.

With reference to FIGS. 1 and 2, the sensor switch units 14 are mounted on the inner wall of the frame 11 and are disposed in the inner space 111 of the frame 11 and are arranged along the rotation path R of the rotating unit 12. The amounts of the sensor switch units 14 correspond to the amounts of the electromagnetic units 13. Each sensor switch unit14 is located between two of the electromagnetic units 13 and includes a start switcher 141 and a stop switcher 142. Preferably, the start switcher 141 and the stop switcher 142 are both infrared ray sensor switches, are sequentially arranged along the anticlockwise direction, and are electrically connected with the electromagnetic units 13. When the rotating arms 121 and the magnetic portions 122 of the rotating unit 12 pass the start switcher 141 or the stop switcher 142, the electromagnetic units 13 are connected to or disconnected from the electricity supply.

The switch device 22 drives the rotating shaft 21 and the rotating unit 12 to rotate, and provides the rotating unit 12 initial rotational movement When the switch device 22 stops, the rotating unit 12 is rotated by the inertia or by the magnetic force of the electromagnetic units 13.

Since the rotating unit 12 rotates, the rotating arms 121 pass the start switcher 141 to start the electric connection of the electromagnetic unit 13 and to generate magnetic force to attract the magnetic portions 122 of the rotating unit 12. The rotating unit 12 keeps rotating along the rotation path R and passes the stop switcher 142 to disconnect from the electricity supply. The previous electromagnetic unit 13 will stop generating magnetic force to attract the previous rotating unit 12. Therefore, the rotation speed of the rotating unit 12 will not be decreased by the magnetic force of the previous electromagnetic unit 13 and will be increased by the magnetic force of the next adjacent electromagnetic unit 13. The electrical generator 2 is driven by the continual rotation of the rotating unit 12 to efficiently generate electric power.

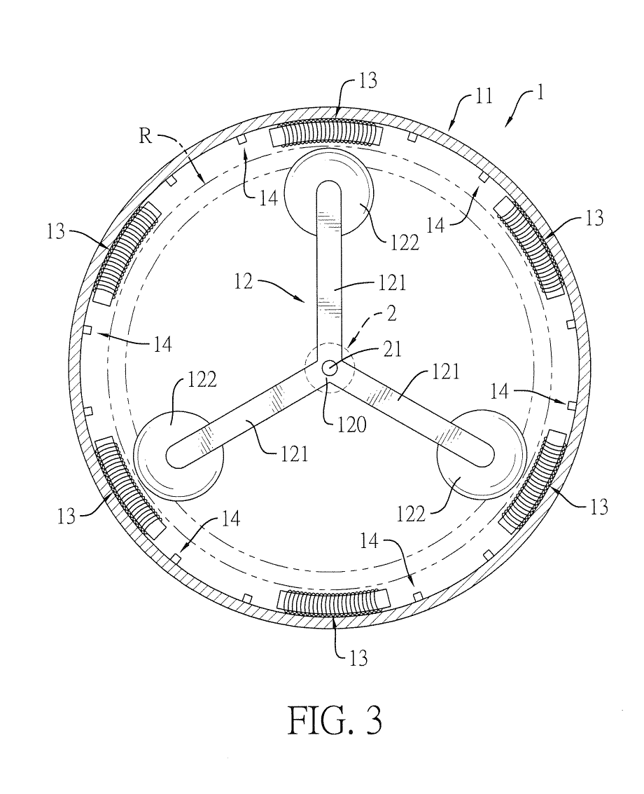

With reference to FIG. 3, in a second preferred embodiment of the rotating driving apparatus 1 in accordance with the present invention, the elements and effects of the second embodiment are same as those of the first embodiment except the rotating unit 12 has three rotating arms 121.

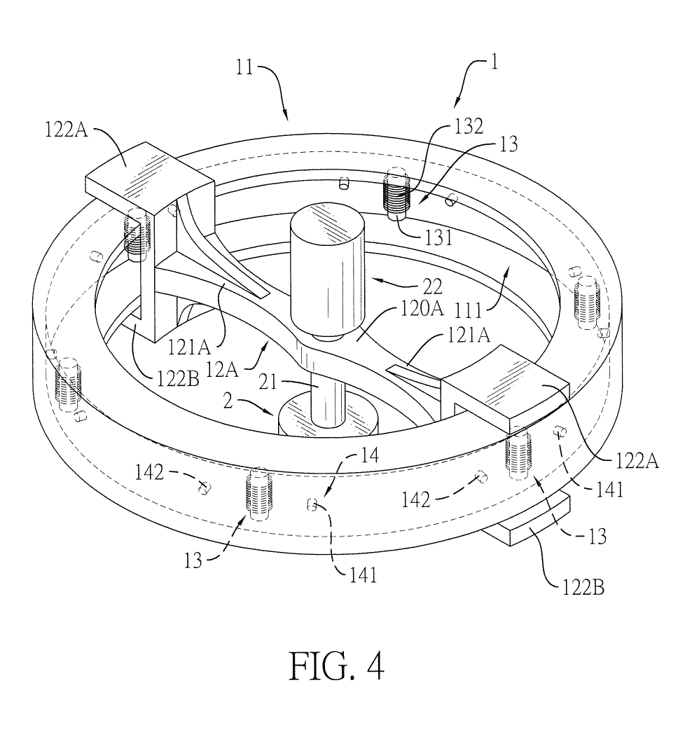

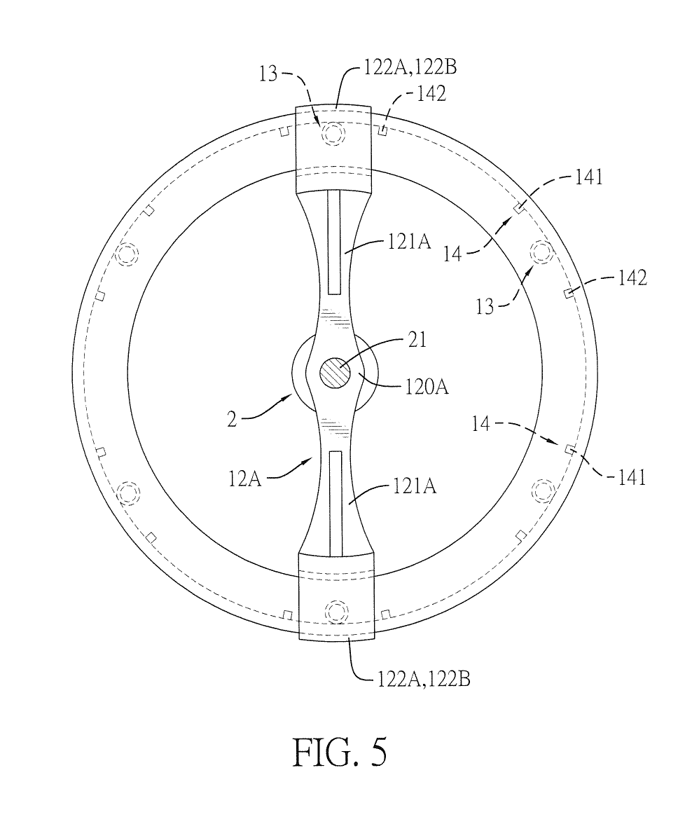

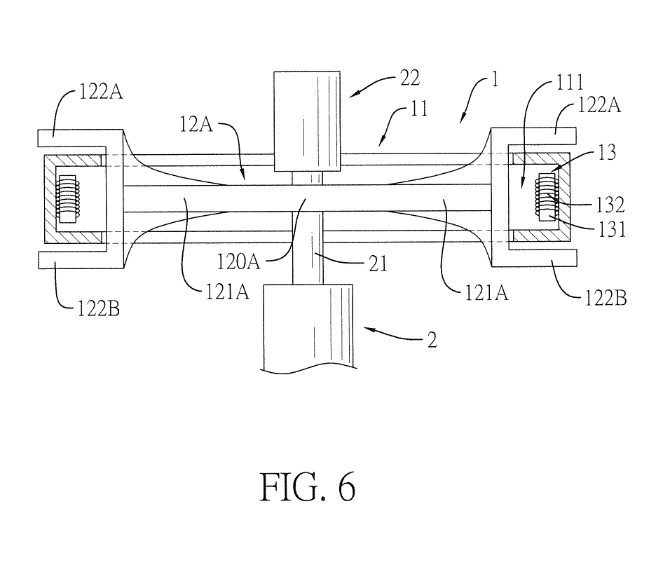

With reference to FIGS. 4 to 6, in a third preferred embodiment of the rotating apparatus 1A in accordance with the present invention, the elements and effects of the second embodiment are same as those of the first embodiment except the rotating unit 12A and the electromagnetic units 13.

The rotating unit 12A has a rotating center 120A, multiple rotating arms 121A and multiple magnetic portions 122. The rotating arms 121A extend from the rotating center 120A toward a radial direction of the rotating shaft 21 and are arranged at identical intervals. Each rotating arm 121A has an end portion. The magnetic portions 122 are respectively mounted on the end portions of the rotating arms 121. Preferably, two rotating arms 121 are implemented and are arranged along a same radial direction and are diametrically opposite to each other. The magnetic portions 122 are U-shaped, are disposed around the frame 11 and each magnetic portion 122 has two magnetic plates 122A, 122B. The magnetic plates 122A, 122B are parallel to each other, are located respectively at two sides of the frame 11, and are parallel to two sides of the frame 11.

The electromagnetic units 13 are longitudinally disposed in the inner space 111 of the frame 11 and are arranged along a periphery of the rotation path R of the rotating unit 12A. The electromagnets 131 of the electromagnetic units 13 are parallel to the rotating shaft 21. When the electromagnetic units 13 are electrified, the magnetic plates 122A,122B are attracted by the electromagnetic units 13, and the rotating unit 12A can be rotated by magnetic force.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A horizontally rotating driving apparatus comprising:
a rotating shaft extending toward a horizontal direction;
a frame mounted on the rotating shaft and having an inner space formed inside the frame;
a rotating unit located in the inner space of the frame, horizontally and rotatably mounted on the rotating shaft to form a rotation path, and including
a rotating center located at a central point of the rotating unit and connected with the rotating shaft;
multiple rotating arms respectively extending from the rotating center and arranged at identical intervals; and
multiple magnetic portions respectively mounted on the rotating arms;
multiple electromagnetic units disposed in the inner space of the frame, arranged along the rotation path of the rotating unit, and respectively mounted in the frame at identical intervals;
multiple sensor switch units mounted in the frame and disposed in the inner space of the frame at identical intervals and arranged along the rotation path of the rotating unit, the amount of the sensor switch units corresponding to the amount of the electromagnetic units;
wherein, when one of the magnetic portions passes the sensor switch units, the sensor switch units sequentially control the electromagnetic units to start or stop generating magnetic force.

2. The rotating apparatus as claimed in claim 1, wherein
each rotating arm has an end portion, and the magnetic portions are respectively mounted on the end portions of the rotating arms;
each electromagnetic unit is located adjacent to the magnetic portions and a periphery of the rotation path of the rotating unit, and includes an electromagnet and a coil coiled around the electromagnet; and
the sensor switch units are respectively and electrically connected with the electromagnetic units, each sensor switch unit is located between two of the electromagnetic units and includes a start switcher and a stop switcher.

3. The rotating apparatus as claimed in claim 1, wherein
each rotating arm has an end portion, and the magnetic portions are respectively mounted on the end portions of the rotating arms;
each magnetic portions has
two magnetic plates parallel to each other, located respectively at two sides of the frame and are parallel to two sides of the frame;
each electromagnetic unit located adjacent to the magnetic portions and a periphery of the rotation path of the rotating unit, and includes an electromagnet and a coil coiled around the electromagnet, the electromagnets of the electromagnetic units are parallel to the rotating shaft; and
the sensor switch units are respectively and electrically connected with the electromagnetic units, each sensor switch unit is located between two of the electromagnetic units and includes a start switcher and a stop switcher.
